(19) United States
(12) Patent Application Publication
(10) Pub. No.: US 2008/0061141 A1
(43) Pub. Date: Mar. 13, 2008

(54) Option selection device

(76) Inventor: Marla B. Abari, Santa Monica, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/520,528

(22) Filed: Sep. 13, 2006

(51) Int. Cl. G06Q 30/00

(52) U.S. Cl. 235/385

(57) ABSTRACT

An option selection system includes at least one manually operable labeled selector switch connected to at least one perceivable indicator device. When the switch is operated, the device provides an instruction. In a retail environment, the switch and indicator device is used to provide an instruction from a customer to a packaging person regarding the type of purchasing desired for the customer's purchase. Multiple switches and indicator are used to provide more complex instructions. Reset systems are employed to clear the indicator devices for the next customer. The indicator device provides visual or auditory instructions. The selector switch is connected to an inventory control system to identify needs for packaging supplies as supplies are depleted. In dining facilities the system may be employed to indicate service on the premises or take-out service. The system is connected to an accounting system to record the appropriate tax treatment for the dining purchase.

### FIELD OF INVENTION

The invention pertains to systems for selecting options. More particularly, the invention relates to an apparatus for allowing a customer to designate desired options or provide a desired response in a retail setting without verbal communications.

### BACKGROUND OF THE INVENTION

In retail settings, customers are often required to answer routine questions repeatedly such as “paper or plastic” when specifying their bagging option choices or “for here or to go” regarding food purchases in establishments that serve food on the premises and also provide take-out service. Many customers are annoyed by having to answer such questions and deal with the frequent misunderstandings resulting from lack of attention on the part of retail service people. The present invention provides an apparatus that permits the retail customer to provide the necessary information without engaging the service person in conversation.

Various designs for option selection devices have been developed to address related problems. U.S. Pat. No. 4,617,457, issued to Granzow, et al., discloses a document cashing system including a host computer, a plurality of ATMs, and a teller station including a display and keyboard including function keys. Each ATM includes an imager for presenting an image of a check received at the machine to the display at the teller station. The image along with other check data and data about the drawer and drawee of the check are displayed to the teller at the teller station who decides whether to accept or not accept the check for cashing by actuating an appropriate function key on the keyboard. A MICR printer within each ATM prints the monetary amount of the check on the associated check for accepted checks when the associated cash is dispensed to the customer by the ATM.

U.S. Pat. No. 5,510,979, issued to Moderi, et al. is directed to a computer system for entering, processing and recording sales of items. This is disclosed to be “especially suitable for use in retail sales, particularly quick service restaurants.” The system includes a plurality of programmable Point of Sale (POS) registers for entering and tabulating customer orders. In another embodiment, each POS register includes a programmable display for displaying a hierarchical menu of a plurality of keys, each of the keys being visually associated with a label of salable items or categories of salable items, and a touch sensitive apparatus for detecting when one of the keys has been touched by a human operator. The programmable display is responsive to the touch-sensitive apparatus so that a human operator can enter a particular salable item into the programmable display by touching the key which is visually associated with the label corresponding to the particular salable item or category in which the particular salable item is included.

U.S. Pat. No. D378,317, issued to Wilke illustrates the ornamental design for a combination skirt and trousers. Fasteners at the top edge of the pants secure the skirt to the trousers. The skirt is split on each side, resulting in a front and a rear panel.

U.S. Pat. No. 6,098,879, issued to Terranova discloses a fuel dispensing system providing customer preferences. The invention teaches a fueling system for automatically providing predefined customer preferences during a fueling operation. These preferences are typically selected by a customer and associated with a remote communication unit, such as a transponder, that is issued to the customer. The preferences may be modified during a fueling transaction. During a fueling transaction, the transponder transmits information that a fueling system uses to automatically provide select information to the customer according to the predefined preferences. As such, the customer associated with the transponder does not have to select information during the transaction that he or she desires. Further, the invention provides for preventing the presentation of select information according to the predefined preferences a combined skirt and shorts that are permanently sewn together at the upper part of the trunk, but are separated below the crotch so that the skirt amounts to a front and rear flap.

U.S. Pat. No. 6,152,591, issued to McCall, et al. is directed to a system for providing a fuel dispenser with a graphics interface. The system easily retrofits onto an existing, conventional fuel dispenser. The system likewise allows a customer to interact with the commercials as well as the instructional interface. The system includes a video display terminal, a touch screen, a multimedia controller, and a pump interface. A conventional fuel dispenser may be readily retrofitted with the system because the multimedia controller and pump interface communicate with a customer activated terminal already on the conventional fuel dispenser. The system also operates in a manner to determine if the customer has used the fuel dispenser before, and if not, displays additional instructions and videos to explain operation of the fuel dispenser. The system also allows the customer to select between different categories of commercials in order to purchase amenities. Furthermore, the system provides a manner in which to reward the customer for such things as frequent purchases and to include all of the purchases on a single receipt.

U.S. Pat. No. 6,497,362, issued to Persky, et al. discloses a method of performing a supervisory function for a self-checkout system including sending a request for supervisory assistance from a self-checkout system to a portable, handheld wireless terminal, receiving the request by the wireless terminal, presenting the request via a display provided with the wireless terminal to a supervisory individual, determining whether the assistance request can be remotely performed through input by the supervisory individual, responding to the request through input by the supervisory individual. The input results in a response being sent from the wireless terminal to the self-checkout system. The response results in the supervisory assistance being performed when the assistance request is remotely performable, and the response results in a notification that supervisory personnel are being dispatched to a location of the self-checkout system when the assistance request can not be remotely performed.

U.S. Pat. No. 6,636,835, issued to Ragsdale-Elliott, et al. describes a wireless maitre d′ system for restaurants the invention includes a system for providing interactive two-way communication between patrons and restaurant service personnel who have direct interaction with the patrons during restaurant encounters. The wireless maitre d′ system includes a first wireless device and a second wireless device. The first wireless device establishes an interactive two-way electronic communication between at least one patron and at least one restaurant service personnel by a wireless communication link, and the at least one restaurant service personnel directly interacts with the at least one patron during a restaurant encounter. The second wireless device engages in the interactive two-way communication ;between the at least one service personnel and the at least one patron by the wireless communication link. The interactive two-way electronic communication includes an order for a retail item from the at least one patron to the at least one restaurant service personnel.

U.S. Pat. No. 6,574,603, issued to Dickson, et al. discloses an in-vehicle interface allowing occupants of the vehicle to place orders from within the vehicle for items provided by a quick-serve restaurant before or after the vehicle reaches a typical order entry position associated with the quick-serve restaurant. Occupants in the vehicle are provided a menu on a display of an in-vehicle interface. The occupants may select any number of desired items to form an occupant order. The occupant order is stored and/or transmitted directly or indirectly to the quick-serve restaurant for processing. Financial information may be sent along with the customer order to effect payment for the occupant order. Preferably, the occupant order is transmitted directly to communication electronics in or associated with a fuel dispenser in an environment associated with a quick-serve restaurant. The dispenser electronics will forward the occupant order to the quick-serve restaurant for processing. Alternatively, the occupant order may be transmitted to the quick-serve restaurant via satellite or ground-based communication systems, which in effect relay information transmitted from the vehicle to communication electronics associated with the quick-serve restaurant.

U.S. Pat. No. 6,574,603, issued to Persky discloses a customized self-checkout system including a self-checkout device for processing items for purchase by a customer, a processor for controlling the operations of the self-checkout device, and a memory for receiving customer profile data. The processor adapts the operation of the self-checkout system in accordance with the customer profile data.

It is an objective of the present invention to provide an apparatus to permit a retail customer to communicate answers to commonly asked questions without verbal communication. It is a further objective to provide an apparatus that permits the customer to make one or more selections in response to the question asked. It is a still further objective of the invention to provide a system that will permit inventory level counts to be decremented based upon answers input by the customer. Finally, it is an objective of the present invention to provide a system that will allow the previous answers supplied by the customer to be stored and recalled by the customer for reuse.

While some of the objectives of the present invention are disclosed in the prior art, none of the inventions found include all of the requirements identified.

### SUMMARY OF THE INVENTION

The present invention addresses all of the deficiencies of prior art option selection inventions and satisfies all of the objectives described above.

(1) An option selection system providing all of the desired features can be assembled from the following components. At least one labeled selector switch is provided. The selector switch is manually operable. At least one indicator device is provided. The indicator device is perceivable and connected to the at least one selector switch. When the labeled selector switch is operated, the indicator device will provide at least one instruction.

(2) In a variant of the invention, a plurality of labeled selector switches is provided. Each of the selector switches is connected to a separately indicating perceivable indicator device. When the plurality of labeled selector switches are operated, each of the indicator devices will provide at least one instruction.

(3) In another variant, the option selection system includes a reset switch. The reset switch permits cancellation of operation of the indicator device after receipt of the instruction.

(4) In still another variant, the selector switch is an electrical switch and the indicator device is electrically operated.

(5) In yet another variant, the indicator device is selected from the group includes: lamps, light emitting diodes, buzzers, bells, chimes and speakers.

(6) In a further variant, the indicator device produces electromagnetic radiation in the spectrum between about 400 nanometers and 700 nanometers.

(7) In still a further variant, the indicator device produces electromechanical radiation.

(8) In yet a further variant, the labeled selector switch is also connected to an inventory control system and operation of the selector switch decrements a count of an item in the inventory control system.

(9) In another variant of the invention, the system is installed in a retail sales environment. The labeled selector switch permits selection of a type of packaging desired and the indicator device provides an instruction as to the desired packaging.

(10) In still another variant, the system is installed in a food service environment. The labeled selector switch permits selection of consumption of food items either of on and off of the premises and the indicator device provides an instruction to indicate the food consumption choice.

(11) In yet another variant, the selector switch is also connected to an accounting system and operation of the selector switch determines tax treatment for a transaction related to the food consumption choice.

(12) In a further variant, a voice-synthesizer module is connected to the indicator device and provides confirmation of the at least one instruction.

(13) In still a further variant, operation of the at least one labeled selector switch changes labeling of the switch and permits the perceivable indicator device to provide either a different or additional instruction.

(14) In a final variant of the invention, operation of the at least one labeled selector switch connected to the indicator device provides at least one instruction that further assistance is required.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of the preferred embodiment of the invention illustrating a rocker switch for selecting packaging type;

FIG. 2 is a perspective view of a second embodiment of the invention illustrating additional selections and a reset switch; and

FIG. 3 is a perspective view of a third embodiment of the invention illustrating a screen for remote indicators, attached inventory control and accounting systems as well as a voice synthesis module.

### DETAILED DESCRIPTION OF THE PREFERRED EMBODIMENT

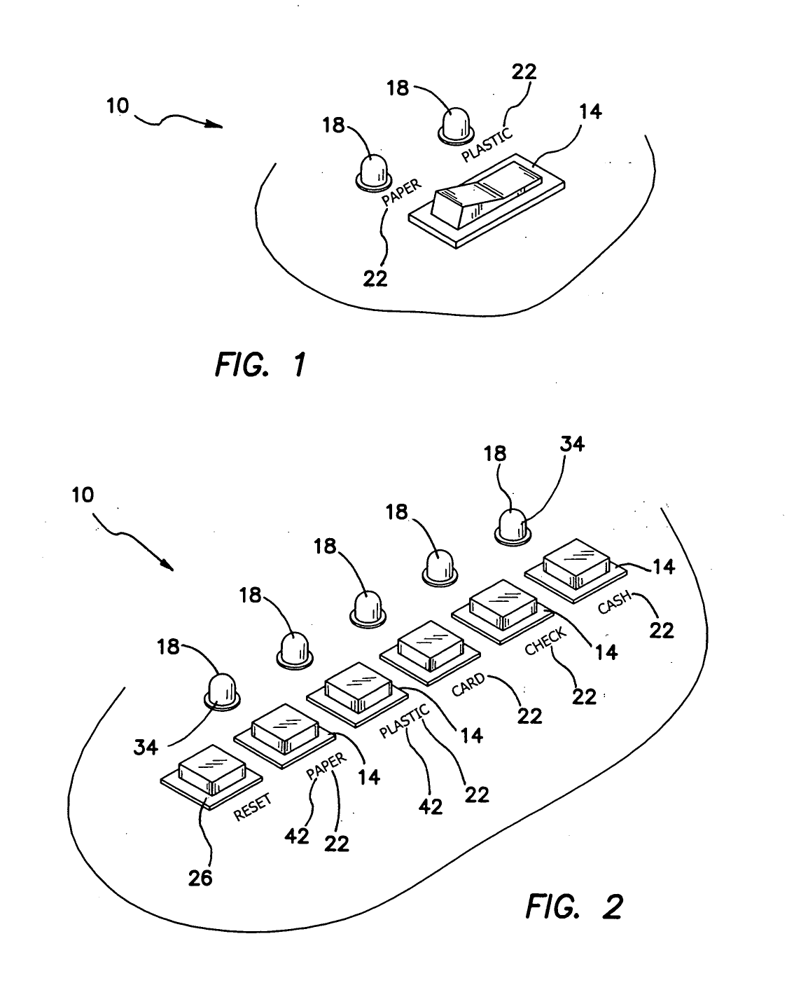

(1) FIGS. 1-3 illustrate an option selection system 10 providing all of the desired features that can be assembled from the following components. As illustrated in FIG. 1, at least one labeled selector switch 14 is provided. The selector switch 14 is manually operable. At least one indicator device 18 is provided. The indicator device 18 is perceivable and connected to the at least one selector switch 14. When the labeled selector switch 14 is operated, the indicator device 18 will provide at least one instruction 22.

(2) In a variant of the invention, as illustrated in FIG. 2, a plurality of labeled selector switches 14 is provided. Each of the selector switches 14 is connected to a separately indicating perceivable indicator device 18. When the plurality of labeled selector switches 14 are operated, each of the indicator devices 18 will provide at least one instruction 22.

(3) In another variant, the option selection system 10 includes a reset switch 26. The reset switch 26 permits cancellation of operation of the indicator device 18 after receipt of the instruction 22.

(4) In still another variant, the selector switch 14 is an electrical switch and the indicator device 18 is electrically operated.

(5) In yet another variant, the indicator device 18 is selected from the group includes: lamps 34, light emitting diodes (not shown), buzzers (not shown), bells (not shown), chimes (not shown) and speakers (not shown).

(6) In a further variant, the indicator device 18 produces electromagnetic radiation in the spectrum between about 400 nanometers and 700 nanometers.

(7) In still a further variant, the indicator device 18 produces electromechanical radiation.

(8) In yet a further variant, as illustrated in FIG. 2, the labeled selector switch 14 is also connected to an inventory control system 38 and operation of the selector switch 14 decrements a count of an item in the inventory control system 38.

(9) In another variant of the invention, as illustrated in FIGS. 1 and 2, the system 10 is installed in a retail sales environment. The labeled selector switch 14 permits selection of a type of packaging 42 desired and the indicator device 18 provides an instruction as to the desired packaging 42.

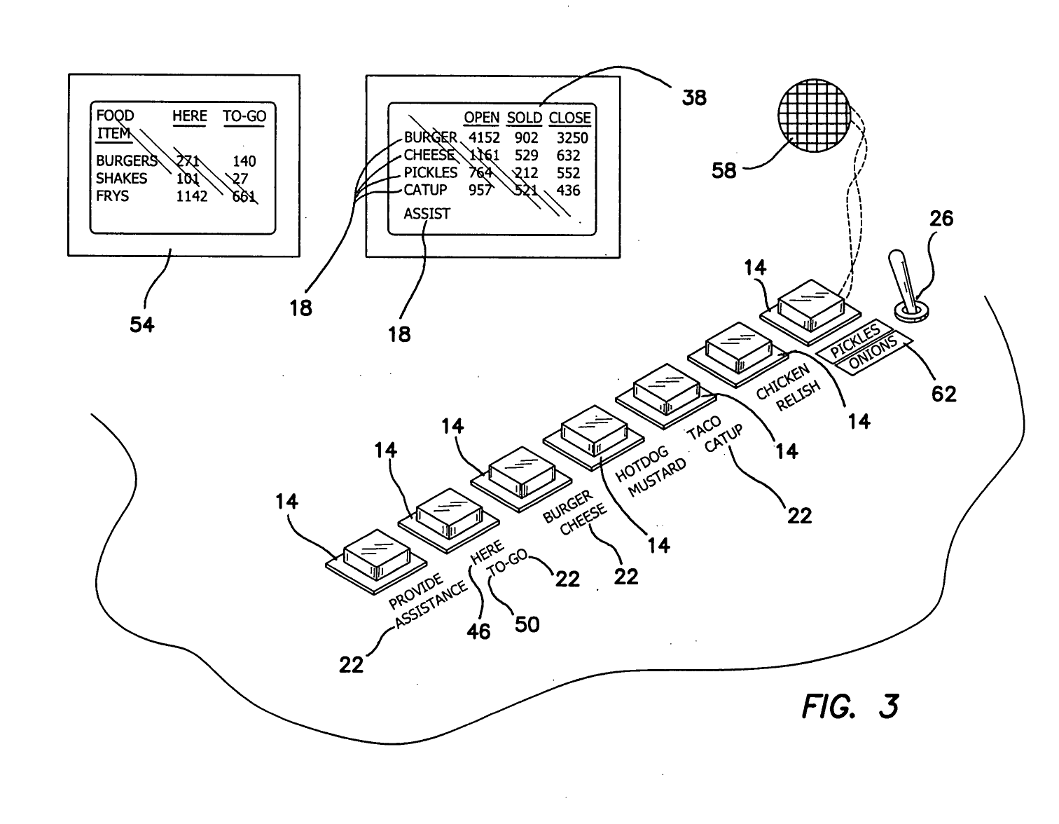

(10) In still another variant, as illustrated in FIG. 3, the system 10 is installed in a food service environment. The labeled selector switch 14 permits selection of consumption of food items either of on 46 and off 50 of the premises and the indicator device 18 provides an instruction 22 to indicate the food consumption choice 46, 50.

(11) In yet another variant, the selector switch 14 is also connected to an accounting system 54 and operation of the selector switch 14 determines tax treatment for a transaction related to the food consumption choice 46, 50.

(12) In a further variant, a voice-synthesizer module 58 is connected to the indicator device 18 and provides confirmation of the at least one instruction 22.

(13) In still a further variant, operation of the at least one labeled selector switch 14 changes labeling 62 of the switch 14 and permits the perceivable indicator device 18 to provide either a different or additional instruction 22.

(14) In a final variant of the invention, operation of the at least one labeled selector switch 14, connected to the indicator device 18, provides at least one instruction 22 that further assistance is required.

The option selection system 10 has been described with reference to particular embodiments. Other modifications and enhancements can be made without departing from the spirit and scope of the claims that follow.

1. An option selection system, comprising:
at least one labeled selector switch, said selector switch being manually operable;
at least one indicator device, said indicator device being perceivable and connected to said at least one selector switch; and
whereby, when said labeled selector switch is operated, said indicator device will provide at least one instruction.

2. The option selection system, as described in claim 1, further comprising:
a plurality of labeled selector switches, each of said selector switches being connected to a separately indicating perceivable indicator device; and
whereby, when said plurality of labeled selector switches are operated, said indicator device will provide at least one instruction.

3. The option selection system, as described in claim 1, further comprising a reset switch, said reset switch permitting cancellation of operation of said indicator device after receipt of said instruction.

4. The option selection system, as described in claim 1, wherein said selector switch is an electrical switch and said indicator device is electrically operated.

5. The option selection system, as described in claim 1, wherein said indicator device is selected from the group comprising:
lamps, light emitting diodes, buzzers, bells, chimes and speakers.

6. The option selection system, as described in claim 1, wherein said indicator device produces electromagnetic radiation in the spectrum between about 400 nanometers and 700 nanometers.

7. The option selection system, as described in claim 1, wherein said indicator device produces electromechanical radiation.

8. The option selection system, as described in claim 1, wherein said labeled selector switch is also connected to an inventory control system and operation of said selector switch decrements a count of an item in said inventory control system.

9. The option selection system, as described in claim 1, wherein said system is installed in a retail sales environment, said labeled selector switch permits selection of a type of packaging desired and said indicator device provides an instruction as to said desired packaging.

10. The option selection system, as described in claim 1, wherein said system is installed in a food service environment, said labeled selector switch permits selection of consumption of food items either of on and off of the premises and said indicator device provides an instruction to indicate said food consumption choice.

11. The option selection system, as described in claim 10, wherein said selector switch is also connected to an accounting system and operation of said selector switch determines tax treatment for a transaction related to said food consumption choice.

12. The option selection system, as described in claim 1, wherein a voice-synthesizer module is connected to said indicator device and provides confirmation of said at least one instruction.

13. The option selection system, as described in claim 1, wherein operation of said at least one labeled selector switch changes labeling of said switch and permits said perceivable indicator device to provide either of a different and additional instruction.

14. The option selection system, as described in claim 1, wherein operation of said at least one labeled selector switch connected to said indicator device provides at least one instruction that further assistance is required.
